(19) United States
(12) Patent Application Publication
(10) Pub. No.: US 2004/0196583 A1
(43) Pub. Date: Oct. 7, 2004

(54) Magnetic recording head, rotary drum unit, and magnetic recording/reproducing method and apparatus using the same

(76) Inventors: Kyoko Suzuki, Kanagawa (JP); Tadashi Ozue, Kanagawa (JP); Shinichi Fukuka, Kanagawa (JP); Toshio Shirai, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/774,201

(22) Filed: Feb. 6, 2004

(30) Foreign Application Priority Data
Feb. 12, 2003 (JP) P2003-034043

(51) Int. Cl. G11B 15/14; G11B 5/02

(52) U.S. Cl. 360/64; 360/21

(57) ABSTRACT

In a helical scan type magnetic recording/reproducing apparatus, input data is encoded into n-channel (e.g., n=4) signals for recording by first to fourth recording heads, and the recorded signal is reproduced by 2n reproducing heads, subjected to a non-tracking process and decoded. In the apparatus, the first to fourth recording heads are configured as a single multi-gap head having four gaps. Each of the heads is made of a lower magnetic pole and an upper magnetic pole through a gap. The core width of the second to fourth heads is formed as a track pitch TP+α1 so as to overlap by α1 with a track pitch TP of the first to third heads to attain a predetermined recording width. The core width of the first head is formed as a track pitch TP+α2 (α2 >α1) . As a result, high-density recording can be implemented.

### CROSS REFERENCE TO RELATED APPLICATION

This application claims priority from Japanese Priority Document No. 2003-034043, filed on Feb. 12, 2003 with the Japanese Patent Office, which document is hereby incorporated by reference.

### BACKGROUND OF THE INVENTION

1. Field of the Invention

The present invention relates to a magnetic recording head, a rotary drum unit, and a magnetic recording/reproducing method and apparatus using the same. More specifically, the invention relates to non-tracking (NT) type helical scan reproducing technology.

2. Description of Related Art

Conventionally, magnetic recording/reproducing apparatuses of an NT (non-tracking) type helical scan system are known in the art as in, e.g., Japanese Examined Patent Application Publication No. H08-34025 (FIGS. 3, 10) and Japanese Patent No. 2513204 (FIG. 1).

As shown in FIG. 18, a conventional helical scan type magnetic recording/reproducing apparatus has a pair of recording/reproducing heads A1, B1 respectively having different azimuth angles (angles in extended direction of head gap) provided on a rotary drum 1, with the heads arranged at close positions through a predetermined step Ds. In addition to this pair of recording/reproducing heads A1, B1, there is provided with another pair of recording/reproducing heads A2, B2, which is 180° apart from the pair of the heads A1, B1. Here, the recording/reproducing heads A1, A2 have the same azimuth angle, and the heads B1, B2 also have the same azimuth angle.

A magnetic tape (not shown) is wrapped around the rotary drum 1 having heads A1, A2, B1, B2 thus arranged, at an angle of 180° or more, to form, as shown in FIG. 21, inclined tracks on the magnetic tape running in a direction slightly inclined with respect to a direction P of the drum rotation. As shown in FIG. 19, the recording/reproducing heads A1, A2, B1, B2 are connected to recording/reproducing (playback) amplifiers 61 to 64 via channels RT1 to RT4 of a rotary transformer, respectively.

And as shown in FIG. 20, the pair of recording/reproducing heads A1, B1 and the pair of recording/reproducing heads A2, B2 are alternately turned on every half rotation of the rotary drum 1 with the paired heads A1, B1 or A2, B2 turned on simultaneously. As a result, as shown in FIG. 21, tracks TA1, TB1 are formed by the pair of recording/reproducing heads A1, B1 during a first half rotation of the drum 1, and tracks TA2, TB2 are formed by the pair of recording/reproducing heads A2, B2 during next half rotation. Digital signal to be supplied to respective pair of recording/reproducing heads A1, B1 and A2, B2 is obtained by time-expanding the single input signal twice to form two parallel input signals for inputting to the recording/reproducing amplifiers 61 to 64. And outputs from the amplifiers 61 to 64 are supplied to the recording/reproducing heads A1, A2, B1, B2 via the channels RT1 to RT4 of the rotary transformer, respectively. Note that recording operation and reproducing operation are not particularly different from each other expect that the flow of signals are reversed. The reproducing method employed here is an NT (non-tracking) reproduction (e.g., Japanese Unexamined Patent Application Publication No. 2001-291201 (FIGS. 1, 2).

An NT reproducing servo for the NT reproduction will be described. During reproduction, reproduced signal rate required as a system is defined by the system. For example, in a system using two reproducing heads under a drum rotation of 6,000 rpm, i.e., 100 Hz, the system operation is normal as long as 100×2 tracks are reproduced per second. And these 100 tracks reproduced by each head per second are expected to be continuous ones. In order to achieve this, the tape must be run to reproduce exactly 100 tracks per second. In order to keep this state, servo control is usually applied to each track. It is checked by some technique that each reproducing head is scanning a target recorded track, and the tape running speed is always adjusted if the head is off the track.

Since a typical servo involves a single reproducing scanning for a single recorded track, a reproducing head must trace throughout a recorded track every time it scans for reproduction. In order to do so, the recorded track angle and the scanning angle of the reproducing head relative to the longitudinal direction of the tape must coincide with each other.

In the NT reproducing technique, the number of reproducing scans is set to a value larger than the number of tracks. Considering the fact that the number of scans is usually set to twice the number of tracks, the following will be discussed based on a double reproducing scanning density. Double-density scanning would not necessarily guarantee that all the scans are made exactly on track. However, the NT reproducing technique would require that data on all the tracks be reproduced either by having one of two scans made right on track or by producing an acceptable signal quality (SNR) by two scans, although the two scans are made off from just on the track.

In the NT reproducing technique, all of a track of data are not expected to be read continuously by single reproducing scanning. It would be sufficient as long as data can be read in one (or more) of an average of two scans, and which scan should provide reproduction of valid data does not matter. Thus, in the NT reproducing technique, the validly reproduced data is once stored in a buffer memory and arranged to a proper order. And a feature of the technique is that reproducing scanning may be performed across a plurality of tracks by increasing the storage capacity of this buffer memory.

Track data is divided into a plurality of blocks. Data error is detected per block and written into the buffer memory. A track address and a block address are written in each block. This address information is requisite for writing data to the buffer memory. Thus, this one block is the minimum unit for confirming the validity of data.

The NT reproducing servo is of a type that derives off-track information from reproduced signal data. By using the buffer memory capable of accommodating many tracks, the servo system is accepted for reproducing data even when a reproducing head scans a smaller number of recorded tracks than the number of tracks storable in the buffer memory, and even when the tape running speed is tentatively too fast or too slow to trace the number of tracks storable in the buffer memory.

The basic concept is that reproduced data is once stored in the buffer memory such that the memory constantly holds half of its storable data therein. The buffer memory outputs data at a fixed rate as required by the system. Thus, the buffer memory would have no input data error unless its input from the reproducing head is too behind to write a requested output, or is too ahead to fill it up. That is, an empty space of ±½ in the buffer memory is reserved.

When the volume of data written to the buffer memory but not yet outputted therefrom exceeds ½ the capacity of the memory, the tape running speed is too fast, and thus it is controlled to decelerate the tape speed. On the contrary, when data in the memory becomes scarce, it is controlled to accelerate the tape speed.

Next, the helical scan type magnetic recording/reproducing apparatus will be described which uses a multi-gap recording head 40 (a recording device having a plurality of gaps) made of a thin-film device (e.g., Japanese Unexamined Patent Application Publication No. 2002-216313 (FIGS. 1, 2)) and a multi-gap reproducing head 50 (a reproducing device having a plurality of gaps) made of, e.g., a MR (magneto-resistance effect thin-film) device (e.g., Japanese Unexamined Patent Application Publication No. 2002-157710 (FIGS. 1, 2)). As shown in FIG. 16, the multi-gap recording head 40 comprises: a lower nonmagnetic substrate 41; a first thin-film magnetic head 40a made of a lower magnetic shield layer 43 laminated on the substrate 41 through an insulating layer 42, a pair of thin-film magnetic poles (45, 46) including a lower magnetic pole 45 for forming a gap 44 and an upper magnetic pole 46 having a coil (not shown) wound therearound, a protection layer 47 and an intermediate magnetic shield layer 48; and a second thin-film magnetic recording head 40b made of this intermediate magnetic shield layer 48, a pair of thin-film magnetic poles (45, 46) laminated on the layer 48, including a lower magnetic pole 45 for forming a gap 44 and an upper magnetic pole 46 having a coil wound therearound, a protection layer 47 and an upper insulating layer 49. This multi-gap recording head 40 is configured to have a track Tr width (head width) W=1.2 μm, a track pitch Tp=1.0 μm, and an overlap between heads=0.2 μm.

As shown in FIG. 17, the multi-gap reproducing head 50 comprises: a lower nonmagnetic substrate 51; a first MR head 50a made of a lower shield layer (magnetic shield material) 52 laminated on the substrate 51, an intermediate magnetic shield layer 53 having a MR device (54, 55, 56) including an intermediate isolation film 54, a MR film 55 and an intermediate isolation film 56, formed therein, and an intermediate shield layer 57; and a second MR head 50b made of this intermediate shield layer 57, an intermediate magnetic shield layer 53 laminated on the layer 57 and having a MR device (54, 55, 56) including an intermediate isolation film 54, a MR film 55 and an intermediate isolation film 56, formed therein, and an upper shield layer 58. The first MR head 50a and the second MR head 50b are horizontally staggered by a head width W (=1.0 μm).

In implementing the above-mentioned high-density helical scan type magnetic recording/reproducing apparatus, the following problems have been encountered.

(1) Its fabrication takes much time due to severe head mounting (height) tolerances which have restricted implementable densities.

(2) Much space is required in the direction of track density since system performance (error rate) must be ensured by an implementable minimum track width in the face of variations in the recorded track width caused by RROs (Repeatable Run-Outs), NRROs (Non-Repeatable Run-Outs), head mounting accuracy and the like.

Additionally, for implementing a multi-channel helical scan tape system having more heads, i.e., for implementing a high transfer rate, the following problems have been addressed.

(1) The number of heads mountable per drum is restricted.

(2) In the NT reproduction, a satisfactory error rate can be ensured by adjusting the tape running speed, but reading speed may likely be reduced and there may also be some difficulty ensuring stable performance (error rate) during read-after-write operation.

(3) It is difficult for a rotary transformer to increase the number of channels in terms of its implementable capacity (size), cost, performance and other factors.

### SUMMARY OF THE INVENTION

In order to solve the above and other problems, the present invention provides a magnetic recording head, a rotary drum unit, and a magnetic recording/reproducing method and apparatus capable of implementing a helical scan type magnetic recording/reproducing apparatus having a high recording density.

In one aspect of the present invention, a magnetic recording head for a helical scan type magnetic recording/reproducing apparatus includes: a multi-gap recording head has “n” gaps and arranged to have a gap allocation pitch so as to record a pattern of tracks adjacent to one another; and a head gap of the multi-gap recording head for recording a last one of the tracks has a wider gap width than other head gaps thereof and has such a gap width as to ensure a predetermined recorded track pitch or wider even if recorded track widths vary.

In another aspect of the present invention, a rotary drum unit for a helical scan type magnetic recording/reproducing apparatus provided with a recording head, a reproducing head, and means for transmitting recording and reproduction signals, wherein the recording head is a multi-gap recording head having “n” gaps, and the gaps are pitched so as to record a pattern of tracks adjacent to one another; and a gap for recording the last one of the tracks has such a gap width as to ensure a predetermined recorded track pitch or wider.

And as the reproducing head, two multi-gap reproducing heads each having “n” gaps are arranged on the rotary drum at an angle of 180° to each other, or a multi-gap reproducing head having “2n” gaps is arranged at an angle of 180° to the multi-gap recording head. Or, two multi-gap reproducing heads each having (n+m) gaps or a multi-gap reproducing head having (2n+m) gaps is mounted, in which “m” gap(s) is added in consideration of tracing fluctuations undergone by the multi-gap reproducing head(s).

In still another aspect of the present invention, a helical scan type magnetic recording/reproducing method for a magnetic recording/reproducing apparatus that includes a multi-gap recording head having “n” gaps, wherein the gaps are pitched so as to record a pattern of tracks adjacent to one another, and a gap for recording the last one of the tracks among “n” gaps has such a gap width as to ensure a predetermined recorded track pitch or wider, the method including the steps of: determining a tape running speed such that a minimum recorded track width can be ensured for overwriting after one rotation of recording completed by the last track; and reproducing the tracks with a multi-gap reproducing head having a gap width which is ½ of a track width or less.

And as the reproducing head, two multi-gap reproducing heads each having “n” gaps are arranged at 180° to each other on a rotary drum, and the two multi-gap reproducing heads are switched on the rotary drum to transmit reproduced signals therefrom via a rotary transformer having “n” recording channels and “n” reproducing channels. Or a multi-gap reproducing head having “2n” gaps is arranged at 180° to the multi-gap recording head on a rotary drum, and the n-channel multi-gap recording head and the multi-gap reproducing head are switched on the rotary drum to transmit reproduced signals from the multi-gap reproducing head via a rotary transformer having “n” recording channels and “n” reproducing channels. Or two multi-gap reproducing heads each having (n+m) gaps or a multi-gap reproducing head having (2n+m) gaps is mounted, in which “m” gap(s) is added in consideration of tracing fluctuations undergone by the multi-gap reproducing head(s).

In a fourth aspect of the present invention, a magnetic recording/reproducing apparatus of a helical scan type, includes a multi-gap recording head having “n” gaps, wherein the gaps are pitched so as to record a pattern of tracks adjacent to one another, and a gap of the multi-gap recording head for recording the last one of the tracks among “n” gaps has a wider gap width than other heads thereof and has such a gap width as to ensure a predetermined recorded track pitch or wider even if recorded track widths vary, whereby to obtain a recorded pattern of narrow tracks.

And two multi-gap reproducing heads each having “n” gaps are arranged at an angle of 180° to each other on a rotary drum. Or a multi-gap reproducing head having “2n” gaps is arranged at an angle of 180° to the multi-gap recording head. Or two multi-gap reproducing heads each having (n+m) gaps or a multi-gap reproducing head having (2n+m) gaps is mounted, in which “m” gap(s) is added in consideration of tracing fluctuations undergone by the multi-gap reproducing head(s).

Therefore, according to the present invention,

1. A helical scan type magnetic recording/reproducing apparatus having multi-channel recording/reproducing heads can be implemented.

(1) Since “n” signals can be read simultaneously, a system with a high transfer rate can be implemented.

(2) A system with high-density recording can be implemented.

a) Fluctuations in recorded track width due to mechanical variations are less restrictive.

b) Even under fluctuations in recorded track width due to mechanical variations, a minimum recorded track width can be ensured to guarantee a specific error rate.

c) A system with higher-density recording can be implemented, compared. with recording densities attained in consideration of fluctuations due to RROs, NRROs, head mounting accuracy and the like.

d) Restrictions on head mounting steps can be made less or none, to increase productivity and hence reduce manufacturing cost.

e) Restrictions on head mounting area can be greatly eased.

2. According to the magnetic recording/reproducing method and apparatus of the invention, reading speed reduction due to RROs, NRROs, head mounting accuracy and the like can be eliminated to ensure stable performance (error rate) even during read after write.

3. Furthermore, as the reproducing head, two multi-gap reproducing heads each having “n” gaps are arranged at 180° to each other on a rotary drum, and the two multi-gap reproducing heads are switched on the rotary drum to transmit reproduced signals therefrom via a rotary transformer having “n” recording channels and “n” reproducing channels. Or a multi-gap reproducing head having “2n” gaps is arranged at 180° to the multi-gap recording head on a rotary drum, and the n-channel multi-gap recording head and the multi-gap reproducing head are switched on the rotary drum to transmit reproduced signals from the multi-gap reproducing head via a rotary transformer having “n” recording channels and “n” reproducing channels. Therefore, the number of channels of the rotary transformer can be minimized, thereby providing advantageous effects in terms of both cost and performance (frequency characteristics and coupling).

### BRIEF DESCRIPTION OF THE DRAWINGS

FIG. 1 shows in a block diagram a signaling system of a magnetic recording/reproducing apparatus according to a first embodiment;

FIG. 2 illustrates an example structure of a multi-gap recording head;

FIG. 3 illustrates an example recorded pattern;

FIG. 4 depicts an image of how reproducing heads trace tracks;

FIG. 5 illustrates the arrangement of heads, rotary transformers and the like on a rotary drum when two multi-gap reproducing heads each having “n” gaps are used;

FIG. 6 illustrates the arrangement of heads, a rotary transformer and the like on a rotary drum when a single multi-gap reproducing head having “2n” gaps is used;

FIG. 7 shows in a block diagram a signaling system of a magnetic recording/reproducing apparatus under the arrangement of FIG. 5;

FIG. 8 shows in a block diagram a signaling system of a magnetic recording/reproducing apparatus under the arrangement of FIG. 6;

FIG. 9 shows an exemplary recorded pattern for illustrating how the minimum track width is ensured;

FIG. 10 depicts an image of how reproducing heads trace tracks when the tracing distance between some of the heads is increased due to RROs;

FIG. 11 depicts an image of how reproducing heads trace tracks with an additional reproducing head;

FIG. 12 shows in a block diagram a NT reproducing servo for reproducing four channels of the same azimuth;

FIGS. 13A to 13C illustrate how a buffer memory of a NT reproducing servo is allocated (an example of no meandering recorded/reproducing track);

FIGS. 14A to 14C illustrate how a buffer memory of a NT reproducing servo is allocated (an example in which each reproduced head crosses five recorded tracks);

FIGS. 15A to 15C illustrate how a buffer memory of a NT reproducing servo is allocated (an example in which each reproduced head crosses seven recorded tracks);

FIG. 16 illustrates the structure of a multi-gap recording head according to a conventional example;

FIG. 17 illustrates the structure of a multi-gap reproducing head according to a conventional example;

FIG. 18 illustrates the arrangement and configuration of heads in a conventional recording/reproducing apparatus;

FIG. 19 illustrates how recording/reproducing heads are connected to recording/reproducing amplifiers in a conventional recording/reproducing apparatus;

FIG. 20 is an operation timing diagram during recording by a conventional recording/reproducing apparatus; and

FIG. 21 illustrates a relationship between a track pattern and heads in a conventional recording/reproducing apparatus.

### DESCRIPTION OF THE PREFERRED EMBODIMENTS

First Embodiment

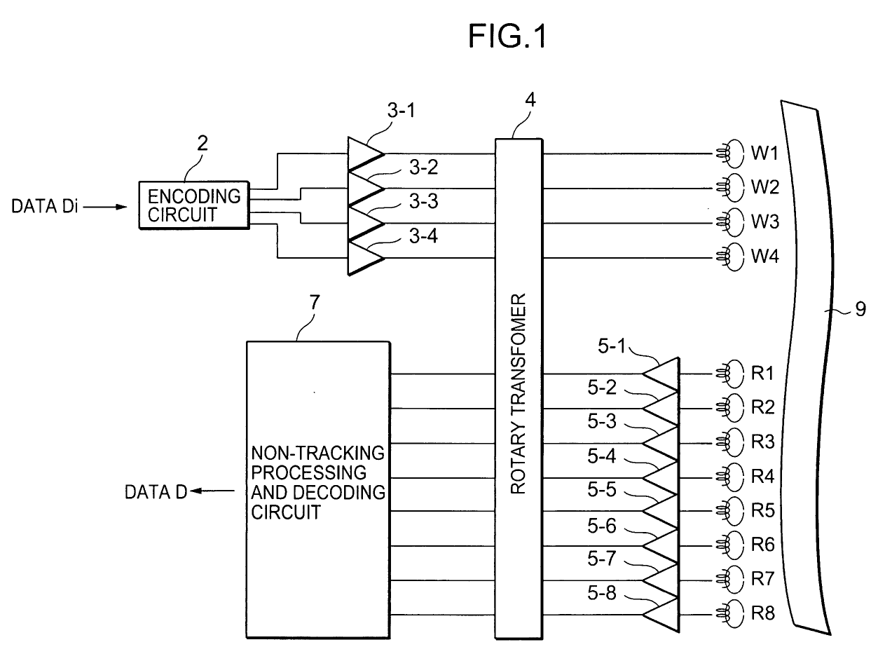

A helical scan type magnetic recording/reproducing apparatus according to an embodiment of the present invention will be described with reference to the drawings. FIG. 1 shows in a block diagram an example configuration of a signaling system of a helical scan type magnetic recording/reproducing apparatus. Input data Di is encoded by an encoding circuit 2, respectively amplified as signals of parallel “n” systems (n=4 in FIG. 1) by recording amplifiers 3-1 to 3-4, and transmitted to recording heads W1 to W4 via recording channels of a rotary transformer (RT) 4, for recording on a magnetic tape 9. These recorded signals are reproduced by “2n” reproducing heads R1 to R8, respectively amplified by head amplifiers 5-1 to 5-8, transmitted to reproducing amplifiers (not shown) via reproducing channels of the rotary transformer 4, for NT processing and decoding by a NT processing/decoding circuit 7.

The recording heads W1 to W4 are configured as a single multi-gap head having four gaps formed by laminating thin-film heads by the technology disclosed in the above-mentioned Japanese Unexamined Patent Application Publication No. 2002-216313. This permits accurate recording of a pattern of narrow tracks. Additionally, the reproducing heads R1 to R8 are configured as a single multi-gap head having eight gaps or two multi-gap heads each having four gaps (their configurations are not shown) using a device, such as a MR device or a GMR device, made by the technology proposed in the above-mentioned Japanese Unexamined Patent Application Publication No. 2002-157710. This allows the reproducing head(s) to trace tracks at a pitch 1/2 of its track width.

The recording heads and the formation of recorded tracks would not be affected by a reproducing method, i.e., whether or not a NT reproducing technique is adopted. In this embodiment, a NT system is employed, which will be described later.

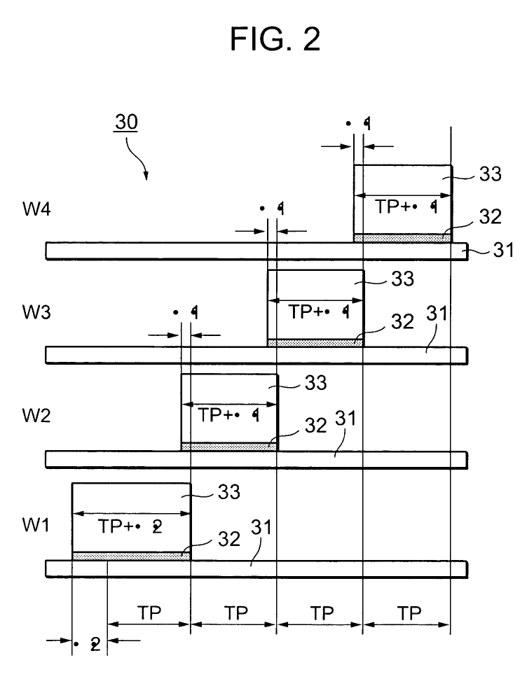

FIG. 2 shows an example structure of a multi-gap recording head. In this example, a multi-gap recording head 30 is configured by laminating thin-film recording heads in which their recording gap is determined by the width of their upper core. Each of recording heads W1 to W4 includes a lower magnetic pole 31 and an upper magnetic pole 33 provided on the lower magnetic pole 31 through a gap 32. The core width CW of the recording heads W2, W3, W4 is designed as a track width TP+α1 so as to overlap by α1 with tracks respectively formed by the recording heads W1, W2, W3. The recording head W1 has the width of its upper magnetic pole 33 (core width) CW formed as a track width TP+α2 so as to project by α2 outward of its track pitch TP (α2>α1). Note that a plurality of such laminated head assemblies may further be arranged in parallel.

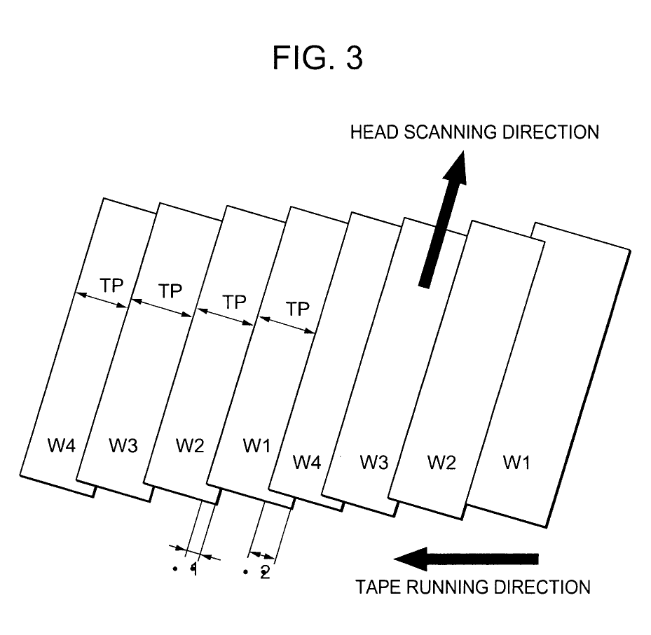

FIG. 3 shows an example magnetic recorded pattern on a magnetic tape by the multi-gap recording head W1 to W4. The width of the recording heads W2, W3, W4 (these heads in the multi-gap head are sometimes called as gaps through this text) of the multi-gap recording head is made larger by α1 than the track pitch TP, whereby a predetermined recording width TP can be attained reliably. The value α1 should be set so as to leave no space between recorded tracks (so as to adequately erase the previous data during overwriting) even under variations undergone by the thin-film heads during their fabrication.

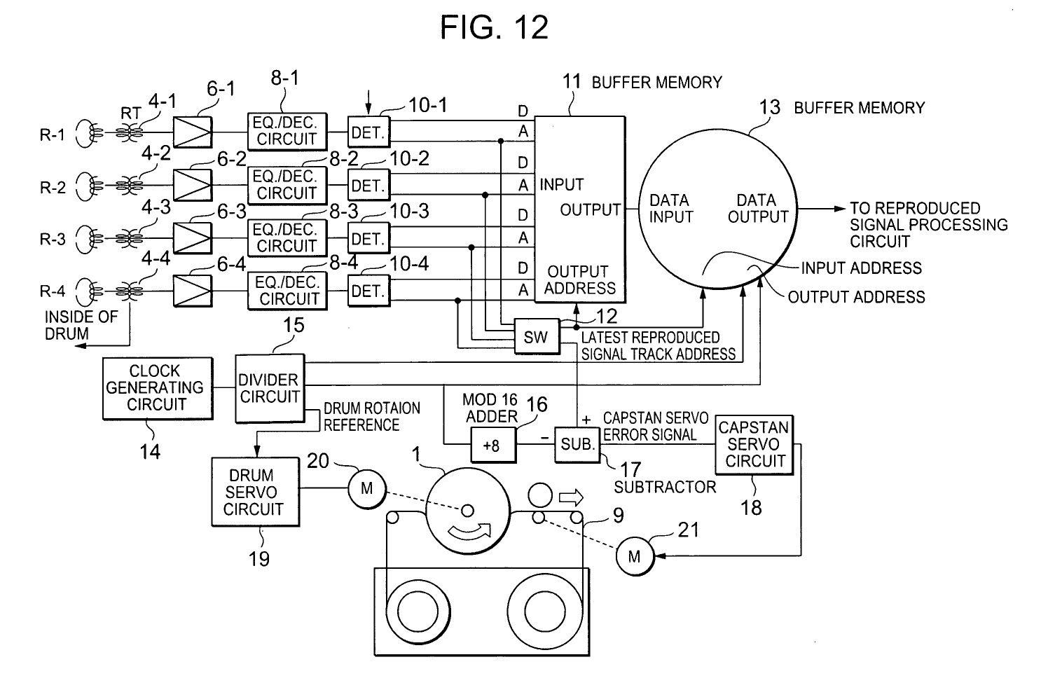

The track width TP is defined by the mounting positions of the recording heads W2, W3, W4 and the tape running speed. The tape running speed is controlled by a capstan servo (FIG. 12) of the NT system to be described later, to achieve a desired tape running speed.

In the case of heads arranged adjacent to one another as those in the above-mentioned multi-gap recording head, the track width TP on the magnetic tape is formed by their positional relationship, but tracks to be overwritten by the recording heads after the drum has completed one rotation may have their width TP formed fluctuated due to RROs/NRROs of the rotary drum, varying magnetic tape running speed, fluctuation of the magnetic tape and the like, thereby making it difficult to precisely form a narrow track pitch.

To overcome this difficulty, the width of the recording head W1 is set to TP +α2, which is wider than the width TP +α1 of each of the recording heads W2, W3, W4, in consideration of some heads being out-of-position after one rotation of the drum. This could provide a recorded pattern wherein tracks are contiguous with no guard-band therebetween, and hence a proper track pitch could be ensured to further permit erasure of old data during overwriting to eliminate causes of deteriorated error rates of the system.

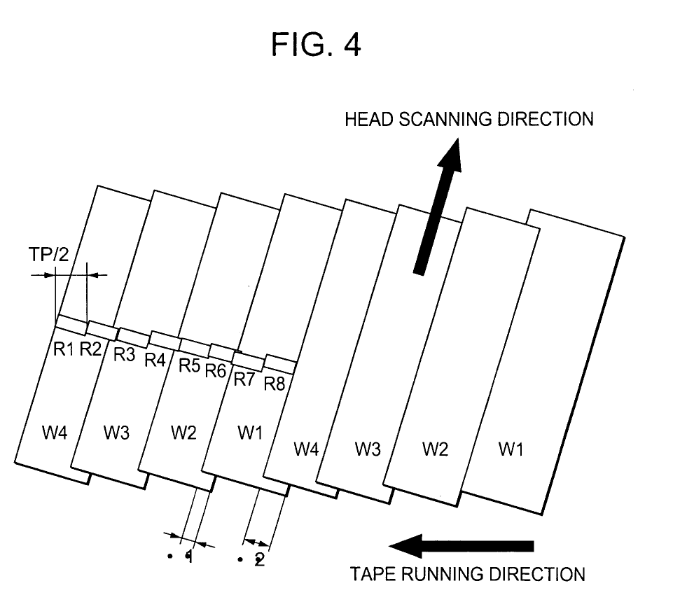

FIG. 4 depicts an image of how reproducing heads trace a track pattern. Reproducing heads R1 to R8 are made of a MR device, a GMR device or the like, having a plurality of gaps as mentioned above, and configured as a multi-gap reproducing head such that data can be reproduced at a pitch (TP/2) which is ½ of their track pitch TP or less on a magnetic tape. When the reproducing gap width is set to ½ of the track width (TP/2) or less, either of the heads in the multi-gap reproducing head can reproduce single track reliably without crossing the adjacent track, to produce a signal having a superior signal quality (SNR) and error rate.

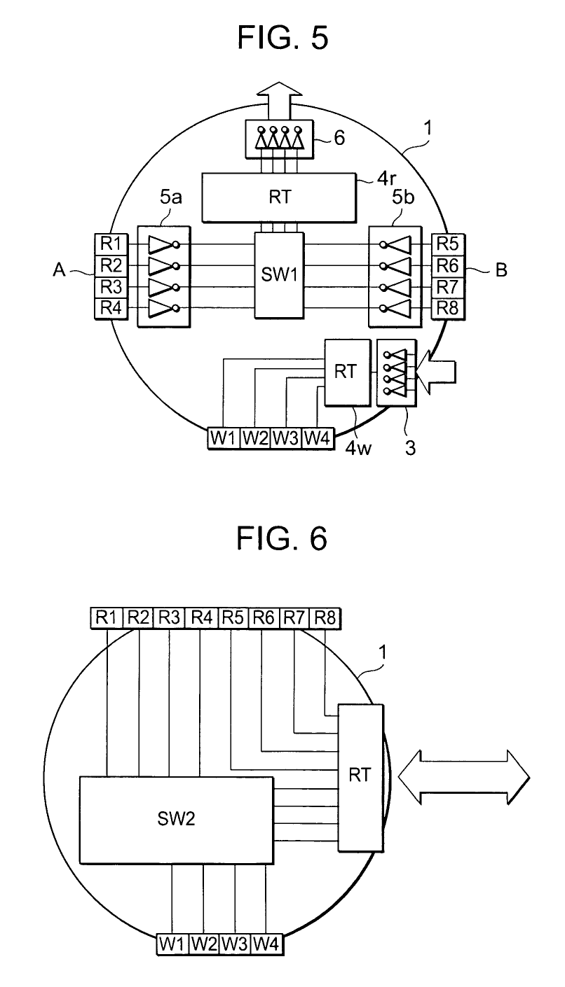

Next, some exemplary arrangements of multi-gap recording heads and multi-gap reproducing heads on a rotary drum will be described. FIG. 5 shows an example arrangement on a rotary drum of a multi-gap recording head having “n” gaps and two multi-gap reproducing heads each having “n” gaps (“n” for recording+n×2 for reproduction), and FIG. 6 shows another example arrangement on a rotary drum of a multi-gap recording head having “n” gaps and a multi-gap reproducing head having “2n” gaps (“n” for recording+“2n” for reproduction). FIGS. 5 and 6 present exemplary configurations and arrangements of reproducing heads in which tracks recorded by “n” heads W1 to W4 are to be reproduced by “2n” heads R1 to R8, as in FIG. 4.

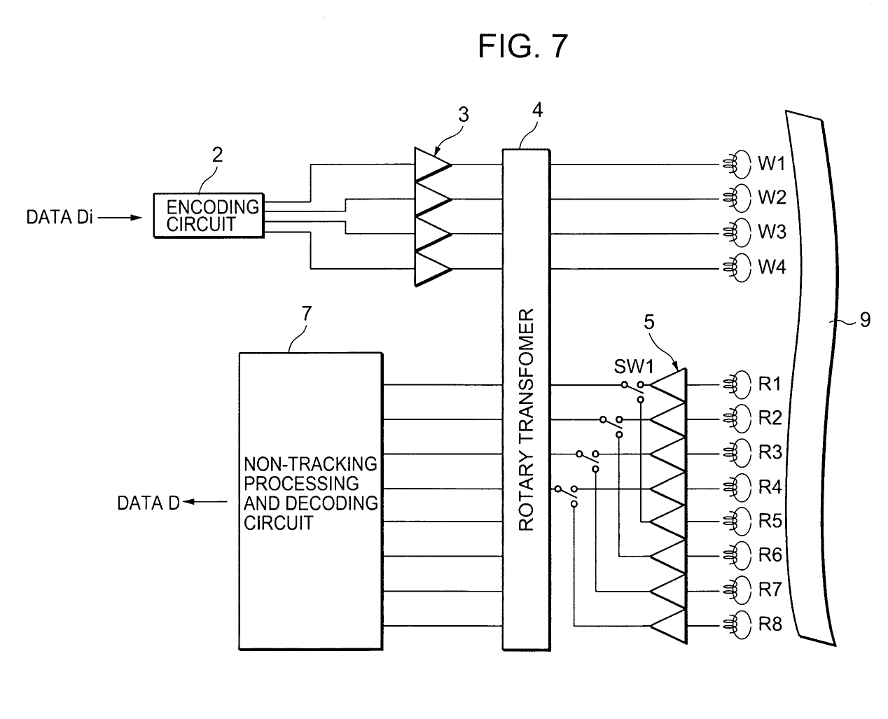

In the case of FIG. 5, “2n” reproducing heads R1 to R8 are configured as two multi-gap reproducing heads A (R1 to R4), B (R5 to R8), and these two multi-gap reproducing heads A, B are arranged opposite to each other on the rotary drum 1 such that tracks they trace make a pattern such as shown in FIG. 4, through reproduction of single track at an angle of 180° or less. Outputs from the heads A (R1-R4), B (R5-R8) are switched over the rotary drum 1 by a switch SW1 as shown in FIG. 7 for transmission to the NT processing/decoding circuit 7 (reproducing amplifiers are not shown) via the reproducing channels of the rotary transformer 4. In this case, the “n” recording heads W1 to W4 are configured as single multi-gap recording head, and laid out at an angle of 90° to both reproducing heads A, B on the drum 1 as shown in FIG. 5. If the reproducing heads are pitched at ½ of their track pitch, simultaneous recording/reproduction (read after write) could also be implemented by the “2n” reproducing heads.

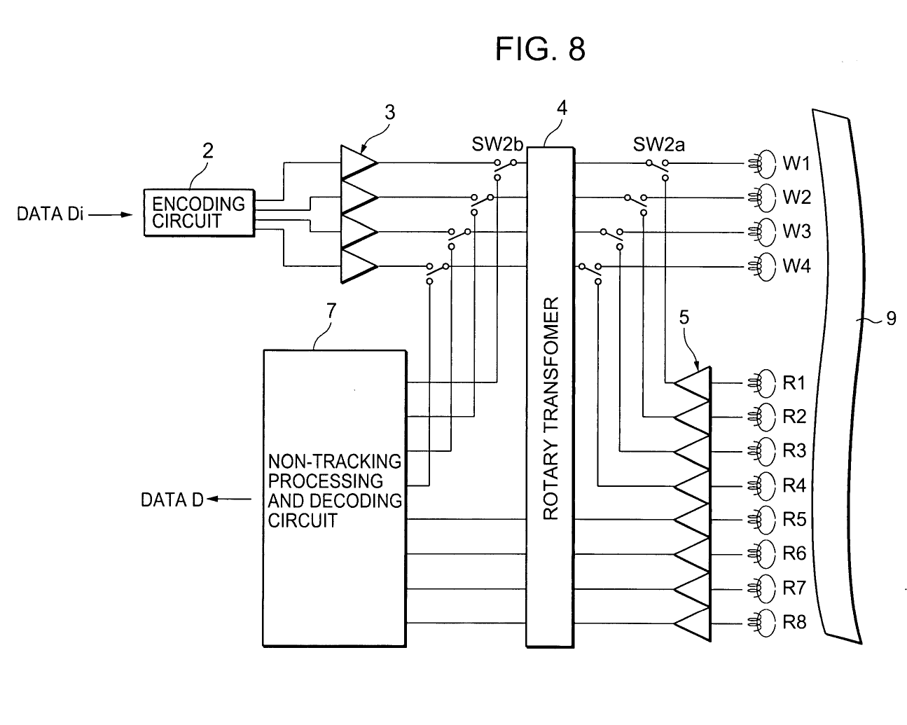

Furthermore, in the case of FIG. 6, “n” recording heads W1 to W4 configured as a single multi-gap recording head and “2n” reproducing heads R1 to R8 configured as a single multi-gap reproducing head are arranged opposite to each other on the rotary drum 1 such that the reproducing heads trace a pattern such as shown in FIG. 4. And as shown in FIG. 8, switches SW2a, SW2b are provided so that the switch SW2a switches output from the recording channels of the rotary transformer 4 between the recording heads W1 to W4 and the reproducing heads R1 to R4, and the switch SW2b switches input to the recording channels of the rotary transformer 4 between the recording amplifiers 3 and the NT processing/decoding circuit 7, to transmit output from the reproducing heads R1 to R4 to the NT processing/decoding circuit 7, utilizing the reproducing channels of the rotary transformer 4. As a result of such a configuration, the transmission can be implemented with a reduced number of channels of the rotary transformer 4.

In achieving high recording densities, when the width of tracks overwritten by the heads after the drum has completed one rotation fluctuates widely with respect to a desired track width, a track pitch is defined to ensure a minimum track width by increasing the width of the last track (formed at last time among recording gaps of the multi-gap recording head), whereby a system could guarantee a specific recording density and satisfactory error rates even under NRROs.

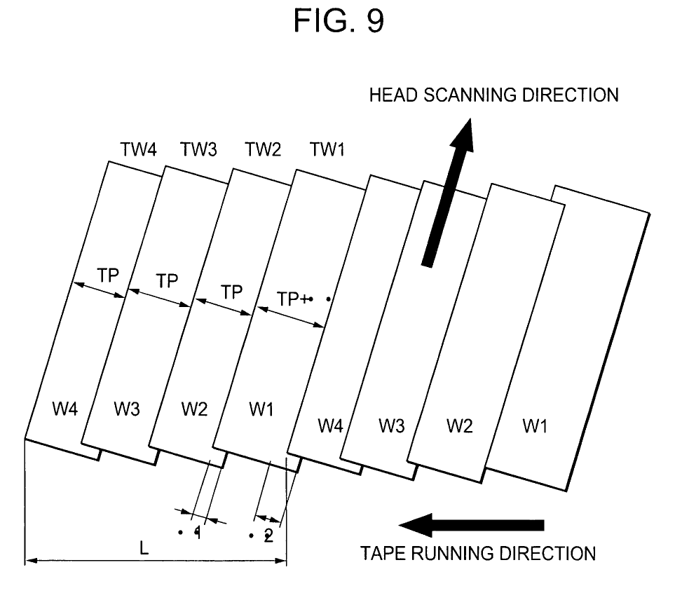

An example of a recorded pattern for ensuring the minimum track width is shown in FIG. 9. As shown in the figure, the track widths TW2 to TW4 formed by the recording heads W2 to W4 are determined only by the designed value and variations undergone during fabrication of the heads (TW2=TW3=TW4=TP), whereas a recorded track width W1 overwritten by the head W1 having completed one round of recording fluctuates due to running speed variations, fluctuation and the like of the tape. In order to accommodate the fluctuation, even if the head W1 is set to the wider width (TP+α2) as mentioned above, the tape running speed is adjusted to make this track width TW1 wider to (TP+β) on the average in order to ensure the minimum track width. By ensuring the minimum track width TP, a risk that only the track width W1 is narrow will be eliminated to guarantee stable reproduction. Note that “L” in FIG. 9 represents the magnetic tape length run per rotation of the drum.

Second Embodiment

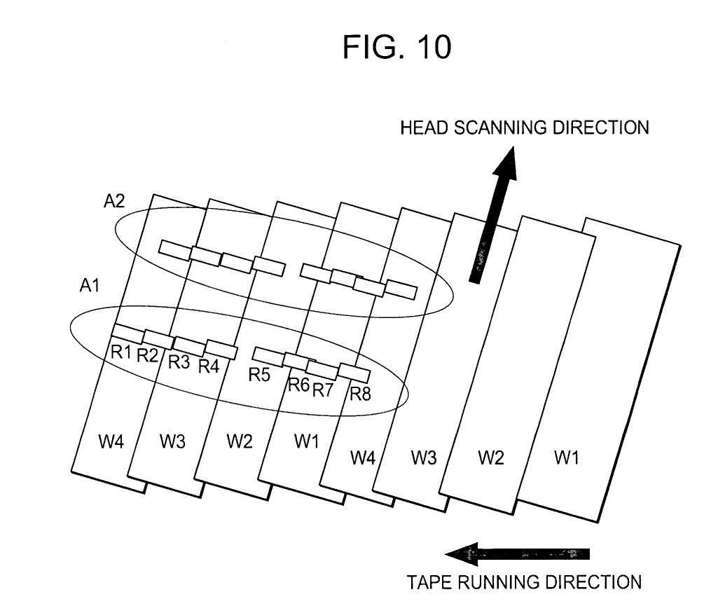

In the case of FIG. 5 referred to above, the reproducing heads may, in some cases, fail to keep an exact pitch of ½ TP between R4, R5 and between R8, R1 when tracing tracks for reproduction after one rotation, as shown by traces A1, A2 in FIG. 10, similarly to the recording heads and depending on the mounting positions of the reproducing heads A (R1 to R4), B (R5 to R8), variations, changes with time, RROs, NRROs and the like. That is, when the reproducing heads trace tracks with an empty space between the heads R4, R5 due to RROs, a portion of the track recorded by the head W2 may not be read on track as in the traces A1, A2.

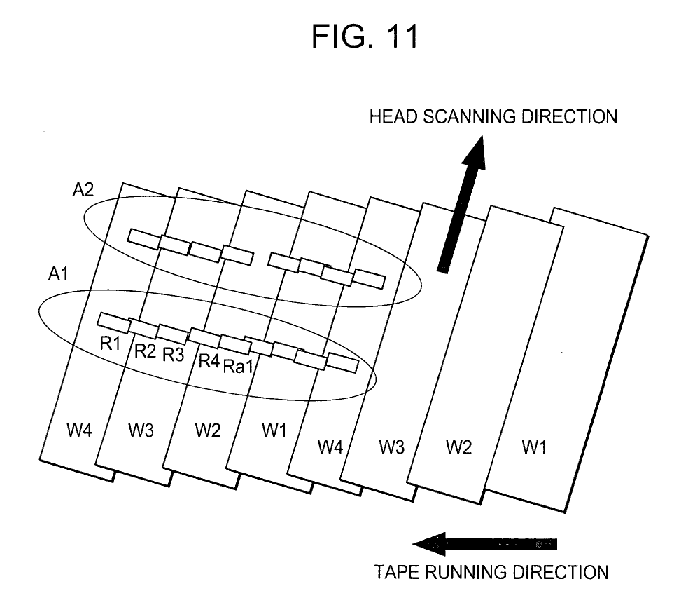

In order to avoid such a risk, two multi-gap reproducing heads each including (n+m) heads wherein “m” head(s) is added to “n” heads are used during non-azimuth recording. FIG. 11 depicts an image of how a reproducing head A (R1 to R4)+single added head (m=1) trace tracks. By adding a head Ra1 to the heads R1 to R4, the difficulty in reproduction encountered in the case of the heads R1 to R4 of FIG. 10 above can be avoided, to permit stable reproduction. In the case of NT reproduction, tracks can be reproduced properly by controlling the tape running speed, but this may impair reading speed. According to this embodiment, however, all aspects of stable transfer rate, low cost and desirable circuit scale can be ensured.

When “2n” reproducing heads are used as in FIG. 6 referred to above, some heads may trace tracks out of position after the drum has completed one rotation. In order to avoid such a risk, a multi-gap reproducing head including (2n+m) heads wherein “m” head(s) is added to “2n” heads is used. As a result, risks of the reproducing heads tracing out of position and of NRROs can be avoided, to permit stable reproduction.

Furthermore, for a tape pattern wherein the track width TW1 is set to a larger value and the other tracks are set to a pitch not exceeding 1/2 TP as in FIG. 9, a multi-gap reproducing head including (2n+m) heads could be used to implement satisfactory reproduction.

In either case, “m” channel(s) will be added to the rotary transformer. Additionally, in arranging two multi-gap reproducing heads each including “n+m” heads and single multi-gap reproducing head including “2n+m” heads as mentioned above, they may be distributed at angles of 90° and 180° to the recording head.

Next, the NT system will be described. FIG. 12 shows in a block diagram a NT reproducing servo for reproduction of four channels of the same azimuth. Since the four heads are complementary in reading recorded tracks of the same azimuth, all of them are the same azimuth heads in the case of azimuth recording. In the following, a description will be given only of azimuth channels in single direction in a full azimuth recording.

Reproduced signals from reproducing heads R1 to R4 mounted on the circumference of a rotary drum 1 are transmitted for amplification to reproducing amplifiers 6-1 to 6-4 outside the rotary drum via reproducing rotary transformers 4-1 to 4-4, and subjected to equalization for their frequency characteristics, timing reproduction, decoding, and demodulation by equalizing/decoding circuits 8-1 to 8-4, respectively. Furthermore, the resultant signals are synchronized by track address/block address/block error detecting circuits 10-1 to 10-4 to identify their track addresses and block addresses for detection of block-based data errors, respectively. These circuits 10-1 to 10-4 then output data D and address information A synchronizing with the data D. The circuits 10-1 to 10-4 may be designed, e.g., such that address information A is utilized to identify data D for writing to a downstream buffer memory 13 by, e.g., outputting address information A for only valid data D free from (or with less) errors to the buffer memory 13 after their detecting addresses.

A memory 11 is a 4-input-1-output buffer memory designed to write four channels of data and switch the written data to single channel for the FIFO (First-In First-Out) buffer memory 13. Output from the memory 11 is supplied in the order of addresses selected by an address order control circuit 12. The address order control circuit 12 controls the order of addresses such that the buffer memory 11 outputs data to the FIFO buffer memory for writing at a proper rate.

Here, the FIFO buffer memory 13 is assumed to have a storage capacity of sixteen tracks. Its output is delivered to a subsequent signal processing circuit at a specified rate in the recorded order of the tracks. The output addresses for controlling this operation are based on a block address signal and a track address signal obtained by causing a frequency dividing circuit 15 to divide a reference clock from a reference clock generating circuit 14.

The FIFO buffer memory 13 must input data at a rate that can keep data stored therein properly (½). The memory 13 having a storage capacity of sixteen tracks has its rate controlled such that the track address of input data is eight tracks behind the track address of output data.

In order to implement this, 8 is added to the track address of the output data by an adder 16, and a difference between the added value and the track address of a latest reproducing signal from the address order control circuit 12 is checked by a subtractor 17. If the difference equals 8 tracks, the subtractor 17 outputs 0. The subtractor 17 outputs a positive error if the input is improperly ahead, and a negative error if the input is improperly behind. A capstan servo circuit 18 controls a capstan motor 21 so as to make the error signal zero. The running speed of the tape 9 is controlled by the rotating speed of the capstan motor 21.

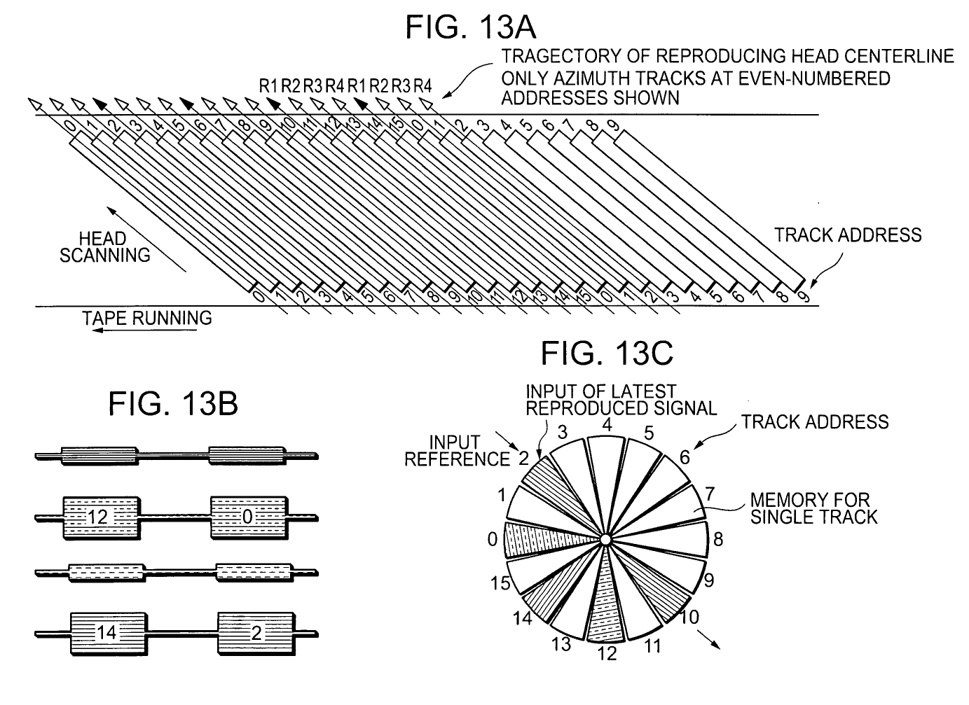

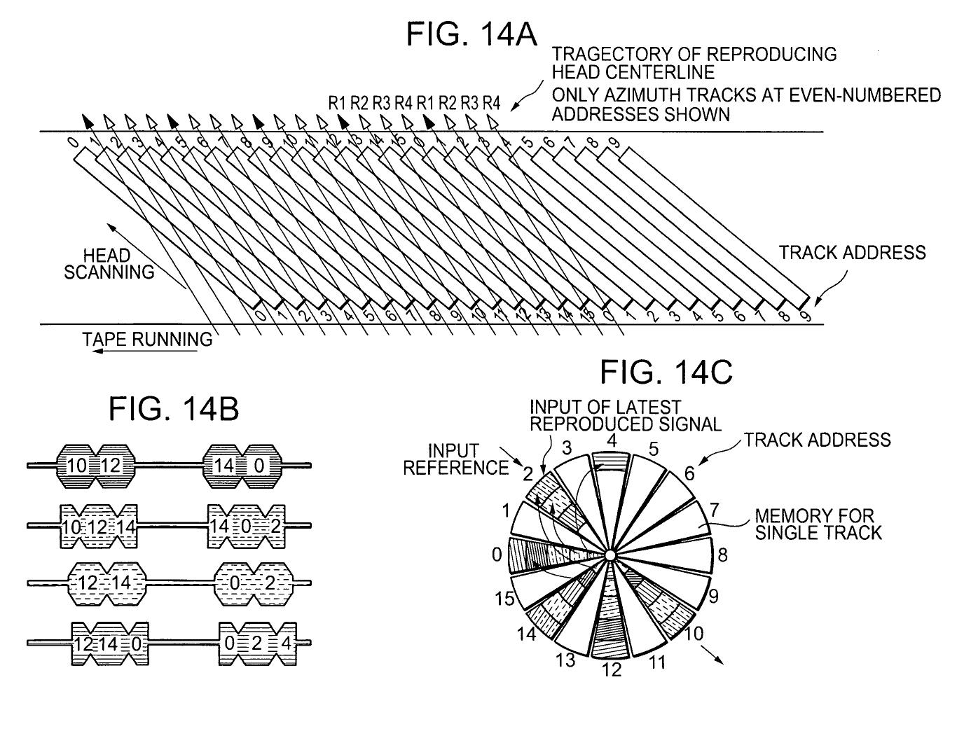

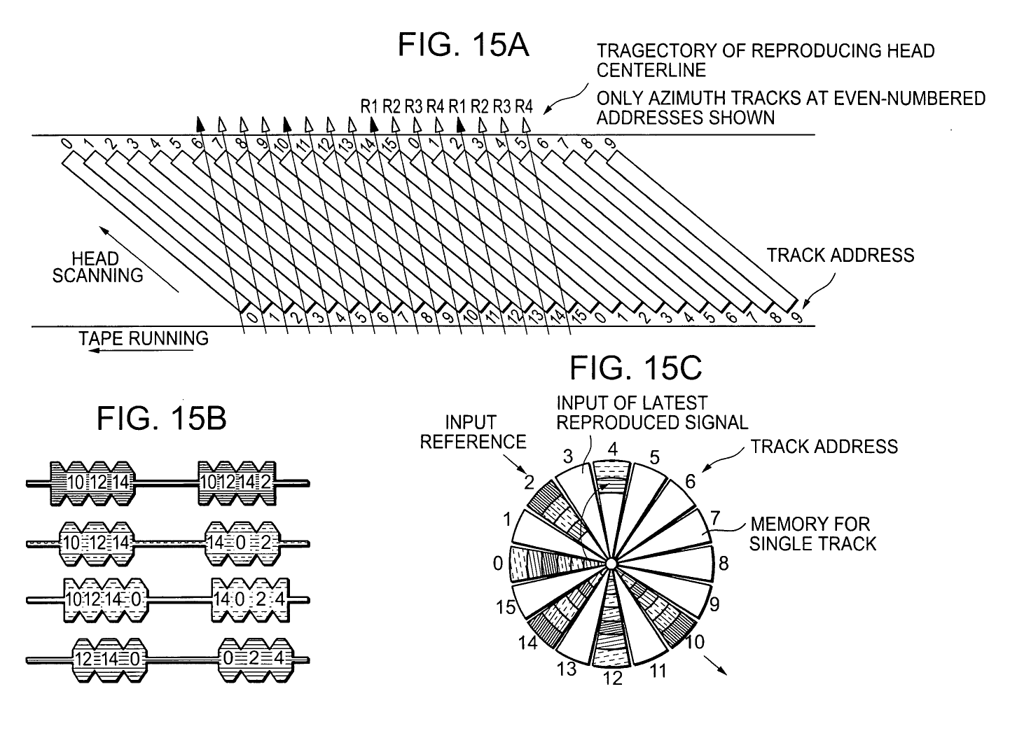

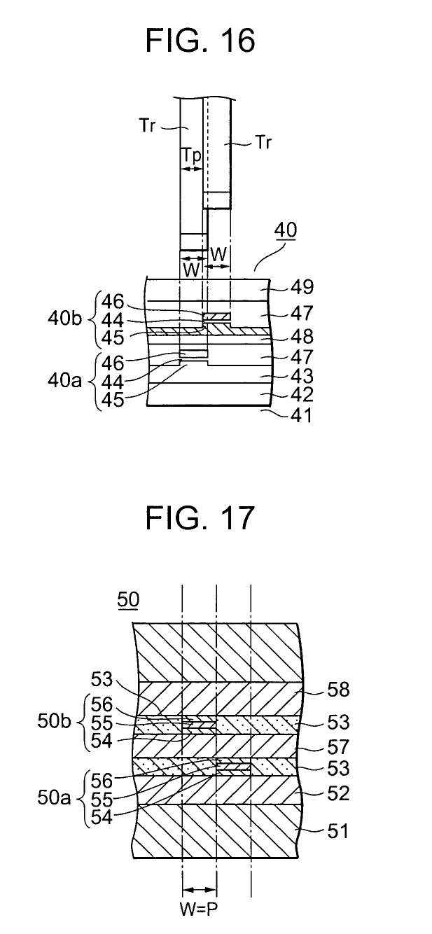

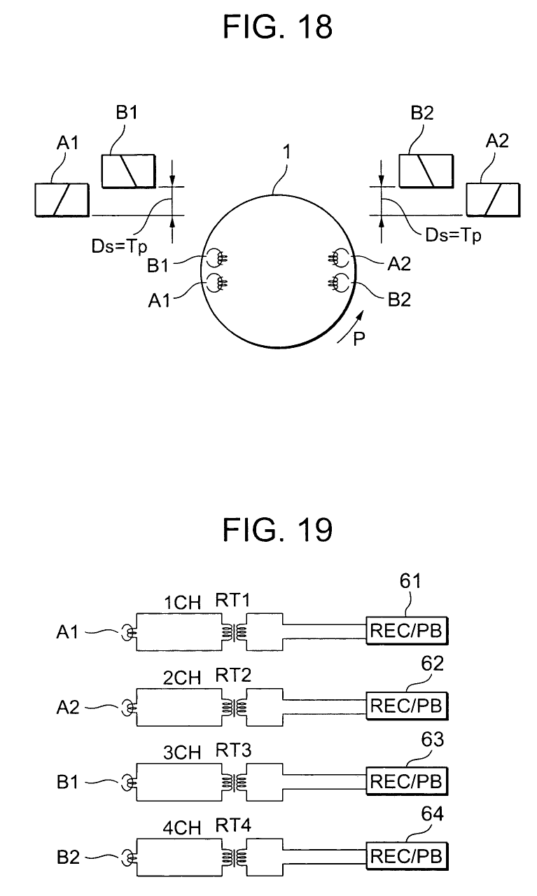

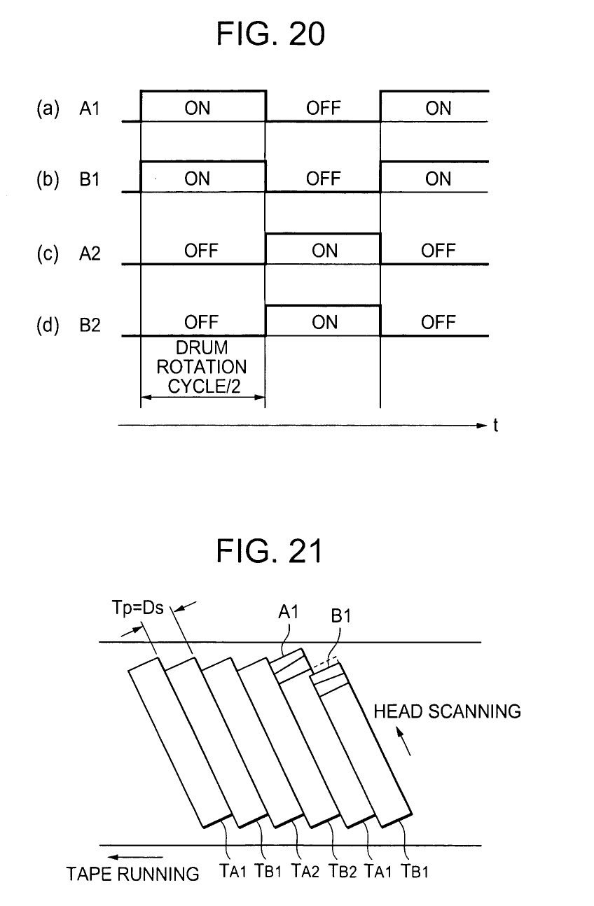

In the following, the operation of the FIFO buffer memory 13 will be described with reference to FIGS. 13A-13C, 14A-14C, and 15A-15C. FIGS. 13A-13C show a case where recorded/reproducing tracks have no meandering and the scanning direction of the reproducing heads coincides with the direction of the recorded tracks. FIGS. 14A-14C show scanning trajectories of the reproducing heads crossing five tracks. FIGS. 15A-15C show scanning trajectories of the reproducing heads crossing seven tracks. Note that the similar to FIGS. 13A to 15C applies independently to odd-numbered tracks which are azimuth tracks in the opposite direction.

In a circular memory map shown in FIG. 13C, 14C or 15C, single track is represented as a sector, and sixteen tracks form a circle. The storage capacity is sixteen tracks. In this case, a cycle of sixteen track addresses should apply. More track addresses would be unidentifiable in the memory. Azimuth recording and an azimuth angle for tracks at even-numbered addresses are herein considered. Furthermore, the same configuration as that of FIG. 12, i.e., use of four reproducing heads for the same azimuth is also considered.

From a track pattern shown in FIG. 13A, 14A or 15A, the scanning trajectories “a” to “d” by the centers of the four reproducing heads R1 to R4 are seen, and an image of their reproduced signal envelopes is depicted in FIG. 13B, 14B or 15B so that one can see which head is reproducing which track. Which signal in the reproduced signal envelopes is decoded and stored in which part of the memory is shown in the memory map of FIG. 13C, 14C or 15C. In each sector which represents single track as mentioned above, the apex represents the head end of the track and the arc its tail end.

In each memory map, data is shown to be read (outputted) from an address 10. After reading the data at the address 10, data at an address 11 is then read. In this way, the reading address turns at a certain speed clockwise around the circular address map. In a proper state, the latest reproduced data is written into the diametrically opposed sector at the same speed as the clockwise outputting speed.

In the case of FIG. 13C, data at a track address 2 is written (inputted). No reading problem would occur even if the tape is accelerated so that data at a track address 8 is being written. However, if the tape is accelerated two tracks ahead to write data at the address 10, i.e., the track for writing (input) coincides with the track for reading (output), then the data for output at the address 10 may be erased by the data for input at the address 10 which is sixteen tracks ahead, before the data for output at the address 10 is read properly. On the contrary, when the tape runs too slowly, no problem would occur until data is written to a track address 12 which is six tracks behind. However, during writing to the address 10, which is eight tracks behind, data for reading (output) may not be written yet.

FIGS. 14A to 14C and 15A to 15C show examples in which a reproducing head crosses a plurality of recorded tracks, so that scanned data for reproduction is written to a plurality of sectors (tracks). In these examples, the range within which a tracking margin affected by the tape speed variations can be reduced by the number of tracks of the same azimuth crossed. For example, the latest reproduced tracks are written in the memory at three addresses 0, 2 and 4. Thus, when the tape runs four tracks ahead, data is written to a track address 8, and when the tape runs four tracks behind, data is written to an area for a track 12. There is a tracking margin reduction of ±2 compared with that of FIGS. 13A to 13C.

When recorded/reproducing track angles deviate, there will be variations in the definition of the latest writing address. It would seem to be appropriate to set the address to the center of a tracking range scanned by the last reproducing head. Alternatively, the latest writing address could be defined as a block address in the middle of the track length.

What is claimed is:

1. A magnetic recording head for a helical scan type magnetic recording/reproducing apparatus comprising:
a multi-gap recording head having “n” gaps, wherein:
said gaps are pitched so as to record a pattern of tracks adjacent to one another; and
a gap for recording the last track among “n” gaps of said multi-gap recording head has a wider gap than other gaps.

2. A rotary drum unit for a helical scan type magnetic recording/reproducing apparatus provided with a recording head, a reproducing head, and means for transmitting recording and reproduced signals, wherein:
said recording head is a multi-gap recording head having “n” gaps, and said gaps are pitched so as to record a pattern of tracks adjacent to one another; and
a gap for recording the last track among “n” gaps of said multi-gap recording head has a wider gap than other gaps.

3. The rotary drum unit according to claim 2, wherein:
two multi-gap reproducing heads each having “n” gaps are arranged at an angle of 180° to each other.

4. The rotary drum unit according to claim 2, wherein:
a multi-gap reproducing head having “2n” gaps is arranged at an angle of 180°0 to said multi-gap recording head.

5. A rotary drum unit capable of recording “n” tracks per rotation, wherein:
two multi-gap reproducing heads each having (n+m) gaps are mounted.

6. A rotary drum unit capable of recording “n” tracks per rotation, wherein:
a multi-gap reproducing head having (2n+m) gaps is mounted.

7. A magnetic recording method for a helical scan type magnetic recording/reproducing apparatus, wherein said apparatus includes a multi-gap recording head having “n” gaps, and said gaps are pitched so as to record a pattern of tracks adjacent to one another; and a gap for recording the last one of said tracks among “n” gaps of multi-gap recording head has a wider recording gap, wherein:
said method comprising the step of:
recording said tracks by determining a tape running speed such that a minimum recorded track width can be ensured when said multi-gap recording head overwrites after one rotation of recording completed by said gap.

8. A magnetic recording/reproducing method in which signals recorded by the magnetic recording method according to claim 7 are reproduced by a multi-gap reproducing head having a head width which is 1/2 of a track width or less, wherein:
two multi-gap reproducing heads each having “n” gaps are arranged at an angle of 180° to each other on a rotary drum as said multi-gap reproducing head; and
said two multi-gap reproducing heads are switched on said rotary drum to transmit reproduced signals therefrom via a rotary transformer having “n” recording channels and “n” reproducing channels.

9. A magnetic recording/reproducing method in which signals recorded by the magnetic recording method according to claim 7 are reproduced by a multi-gap reproducing head having a head width which is 1/2 of a track width or less, wherein:
a multi-gap reproducing head having “2n” gaps is arranged at an angle of 180° to said multi-gap recording head on a rotary drum as said multi-gap reproducing head; and
said n-channel multi-gap recording head and said multi-gap reproducing head are switched on said rotary drum to transmit reproduced signals from said multi-gap reproducing head via a rotary transformer having “n” recording channels and “n” reproducing channels.

10. A magnetic recording/reproducing method for reproducing signals recorded by the magnetic recording method according to claim 7, wherein:
said signals are reproduced by two multi-gap reproducing heads each having (n+m) gaps.

11. A. magnetic recording/reproducing method for reproducing signals recorded by the magnetic recording method according to claim 7, wherein:
said signals are reproduced by a multi-gap reproducing head having (2n+m) gaps.

12. A helical scan type magnetic recording/reproducing apparatus comprising:
a multi-gap recording head having “n” gaps, wherein said gaps are pitched so as to record a pattern of tracks adjacent to one another; and
a gap for recording the last track among said multi-gap recording head has a wider recording gap than other gaps to obtain a recorded pattern of narrow tracks.

13. The magnetic recording/reproducing apparatus according to claim 12, wherein:
two multi-gap reproducing heads each having “n” gaps are arranged at an angle of 180° to each other on a rotary drum.

14. The magnetic recording/reproducing apparatus according to claim 12, wherein:
a multi-gap reproducing head having “2n” gaps is arranged at an angle of 180° to said multi-gap recording head.

15. A magnetic recording/reproducing apparatus capable of recording a pattern of “n” tracks per rotation, wherein: two multi-gap reproducing heads each having (n+m) gaps are mounted.

16. A magnetic recording/reproducing apparatus capable of recording a pattern of “n” tracks per rotation, wherein:
a multi-gap reproducing head having (2n+m) gaps is mounted.
